(19) United States
(12) Patent Application Publication
(10) Pub. No.: US 2021/0237427 A1
(43) Pub. Date: Aug. 5, 2021

(54) PRINTING METHOD AND PRINTING APPARATUS

(71) Applicant: SCREEN HOLDINGS CO., LTD., Kyoto (JP)

(72) Inventor: Shuji MURAMOTO, Kyoto (JP)

(21) Appl. No.: 17/267,370

(22) PCT Filed: Jun. 7, 2019
(86) PCT No.: PCT/JP2019/022657

§ 371 Date: Feb. 9, 2021

(30) Foreign Application Priority Data
Aug. 20, 2018 (JP) 2018-153845

(51) Int. Cl. B41F 17/22; B41M 1/10; B41M 1/14; B41F 23/04; B41F 3/20; B41J 2/01

(52) U.S. Cl. CPC B41F 17/22; B41M 1/10; B41J 2/01; B41F 23/0453; B41F 3/20; B41M 1/14

(57) ABSTRACT

A printing method according to the invention comprises forming a printing pattern of ink on a surface of an intermediate transfer member, transferring the printing pattern by causing the printing target surface to abut on the surface of the intermediate transfer member while supporting the printing target material by making a backup member abut on the printing target surface, increasing viscosity of the ink to predetermined viscosity by irradiating the printing pattern transferred to the printing target surface with first light, and curing the ink by irradiating the printing pattern with second light. The first light is applied to a region, out of the printing target surface, in a state that after departing from the intermediate transfer member and before abutting on the backup member. The second light is applied while the printing target material is separated from the intermediate transfer member.

### TECHNICAL FIELD

The present invention relates to a printing technique of performing printing on a circular cylindrical surface of a printing target material as a printing target surface.

### BACKGROUND ART

There has been a need for performing printing on a printing target material having a printing target surface of a circular cylindrical shape such as a glass bottle, for example. A printing technique responsive to such a need has conventionally been suggested. For example, the disclosure of a technique in PTL 1 relates to a printing apparatus that performs multicolor printing on a surface of a circular cylindrical printing target material. According to this publicly-known technique, ink patterns of multiple colors are supported on a surface of a circular cylindrical blanket roll, and the circular cylindrical printing target material is rotated while abutting on the blanket roll. By doing so, the ink patterns having shapes like the blanket roll are transferred sequentially to the printing target material. The ink patterns in multiple layers are superimposed on each other on the printing target surface to fulfill multicolor printing.

Regarding ink, UV ink to be cured by irradiation with ultraviolet light is used. The ink patterns transferred to the printing target material are irradiated with ultraviolet light to cure the ink patterns, thereby avoiding color mixture between the inks. The disclosure further includes that curing process is unnecessary for each layer depending on ink, and curing process is unnecessary for superimposed printing using the same ink color.

In the printing apparatus disclosed in PTL 1, to prevent ultraviolet light to be applied to ink on the printing target material from entering the blanket roll and to prevent curing of the ink yet to be transferred, a light-shielding plate is arranged between an irradiation light source and the blanket roll.

### CITATION LIST

### Patent Literature

[PTL 1] JP2017-196887A

### SUMMARY OF INVENTION

### Technical Problem

The foregoing technique disclosed in patent literature 1 has the following problems to be solved. First, for formation of printing patterns in multiple layers in piles on a surface of a printing target material, if a layer formed previously is in a completely cured state, adhesion with an additional layer may be reduced. In particular, photo-curing ink forms a firm coating film even by light irradiation in a short period of time, resulting poor adhesion with a printing pattern to be transferred next.

In view of this, for implementation of such superimposed printing, a printing pattern transferred previously desirably maintains a certain degree of softness during transfer of a next printing pattern. On the other hand, if the viscosity of ink already transferred is too low, ink may be mixed during transfer of an additional printing pattern to cause a risk of printing quality reduction. Also, a risk of re-transfer of ink from the printing target material is caused as a result of abutting contact with a peripheral member such as the blanket roll. Thus, ink on the printing target material is desired to be controlled at proper viscosity during implementation of the superimposed printing. Specifically, the viscosity of the ink is desirably higher than viscosity in a state immediately after the transfer and lower than viscosity in a completely cured state. However, the technique disclosed in PTL 1 finds difficulty in controlling such cured states.

In some cases, a printing target material has light-transmitting properties. In such cases, it is inevitable that light applied to the printing target material enters ink yet to be transferred on the blanket roll by transmitting through the interior of the printing target material.

### Solution to Problem

The present invention has been made in view of the foregoing problems and is intended to provide a technique capable of suppressing re-transfer of ink to a peripheral member by controlling the viscosity of the ink properly after being transferred to a printing target material, capable of suppressing curing of ink yet to be transferred, and capable of performing multilayer printing favorably.

One aspect of the present invention is directed to a printing method of performing printing on a printing target material having a circular cylindrical surface as a printing target surface. To accomplish the foregoing intention, the printing method comprises: a first step of forming a printing pattern of ink on a surface of an intermediate transfer member; a second step of supporting the printing target material by making a backup member abut on the printing target surface and of transferring the printing pattern to the printing target surface by causing the printing target surface to abut on the surface of the intermediate transfer member and by causing the printing target material to roll along the surface of the intermediate transfer member; a third step of increasing viscosity of the ink to predetermined viscosity by irradiating the printing pattern transferred to the printing target surface with first light; and a fourth step of curing the ink by irradiating the printing pattern with second light. In the third step, the first light is applied to a region of the printing target surface of the printing target material abutting on the intermediate transfer member and rolling, the region being a part of the printing target surface in a state that after departing from the intermediate transfer member and before abutting on the backup member, and in the fourth step, the second light is applied while the printing target material is separated from the intermediate transfer member.

Another aspect of the present invention is directed to a printing apparatus for printing on a printing target material having a circular cylindrical surface as a printing target surface. To accomplish the foregoing intention, the printing apparatus comprises: an intermediate transfer member which temporarily holds a printing pattern of ink; a holder which holds the printing target material by making a backup member abut the printing target surface and make the printing target surface abut on a surface of the intermediate transfer member; a driver which rolls the printing target material along the surface of the intermediate transfer member; a first light irradiator which irradiates the printing target surface with first light at a position downstream from an abutting position with the intermediate transfer member and upstream from an abutting position with the backup member as viewed in a moving direction of the printing target surface of the printing target material and increases viscosity of the ink to predetermined viscosity; a mover which moves the printing target material after being irradiated with the first light and the intermediate transfer member relative to each other to positions separated from each other; and a second light irradiator which irradiates the printing target material separated from the intermediate transfer member with second light and cures the ink.

If the ink is photo-curing ink, for example, ultraviolet light is usable as the first light and the second light. If the ink is thermosetting ink, for example, infrared light is usable as the first light and the second light.

According to the invention having the foregoing configuration, use of the first light applied to the printing pattern transferred to the printing target material is not for curing the ink completely but for fulfilling the predetermined viscosity. In other words, an exposure amount applied to the ink from the first light is not required to be an exposure amount required for curing the ink. Setting an exposure amount to be applied appropriately allows the ink to be controlled at proper viscosity. This makes it possible to suppress re-transfer of the ink to a peripheral member. This further makes it possible to ensure adhesion between layers of printing patterns during implementation of multilayer printing. As a result, the multilayer printing can be performed favorably.

In causing the printing target material to abut on the intermediate transfer member, the printing target material is supported through the abutting contact of the backup member with the printing target material. Thus, a pressure of the contact between the printing target material and the intermediate transfer member is stabilized. This provides favorable quality and stabilization to transfer of a printing pattern from the intermediate transfer member to the printing target surface of the printing target material or to a printing pattern on the printing target surface already transferred. This also encourages acquisition of favorable printing quality. As the printing pattern already transferred to the printing target material is irradiated with the first light before abutting on the backup member, re-transfer of this printing pattern to the backup member is prevented before it occurs.

Even if the printing target material has light-transmitting properties and applied light enters the intermediate transfer member through the interior of the printing target material, for example, the applied first light is inherently not to cure the ink completely. Therefore, limitation is imposed on increase in the viscosity of the ink on the intermediate transfer member. This makes it possible to reduce the occurrence of transfer failure to be caused during transfer from the intermediate transfer member to the printing target material. On the other hand, the second light for curing the ink completely is applied while the printing target material is separated from the intermediate transfer member. This makes it relatively easy to prevent the light from reaching the ink on the intermediate transfer member. Specifically, this avoids curing of the ink on the intermediate transfer member to be caused by irradiation with the second light.

### Advantageous Effects of Invention

As described above, according to the present invention, the ink is cured through light irradiation at two stages, irradiation with the first light performed immediately after transfer to the printing target material, and subsequent irradiation with the second light. This allows control on the viscosity of the ink after being irradiated with the first light. Thus, it is possible to suppress re-transfer to the backup member or to the intermediate transfer member and to suppress curing of the ink on the intermediate transfer member. This further allows multilayer printing to be performed favorably.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF DRAWINGS

FIG. 1 is a schematic view showing an exemplary schematic configuration of a printing system capable of implementing a printing method according to the present invention.

FIG. 2 is a drawing showing the configurations of the plate stage unit and the ink filling unit.

FIG. 3A is a drawing showing the configuration of the bottle holding unit.

FIG. 3B is a drawing showing the configuration of the bottle holding unit.

FIG. 4 is a flowchart showing one embodiment of the printing method according to the present invention.

FIG. 5 is a drawing schematically showing the motion of each component during the course of implementation of the printing method of FIG. 4.

FIG. 6 is a drawing schematically showing the motion of each component during the course of implementation of the printing method of FIG. 4.

FIG. 7 is a drawing schematically showing the motion of each component during the superimposed printing.

FIG. 8A is a drawing explaining a problem relating to leakage of light to the blanket.

FIG. 8B is a drawing explaining a problem relating to leakage of light to the blanket.

### DESCRIPTION OF EMBODIMENTS

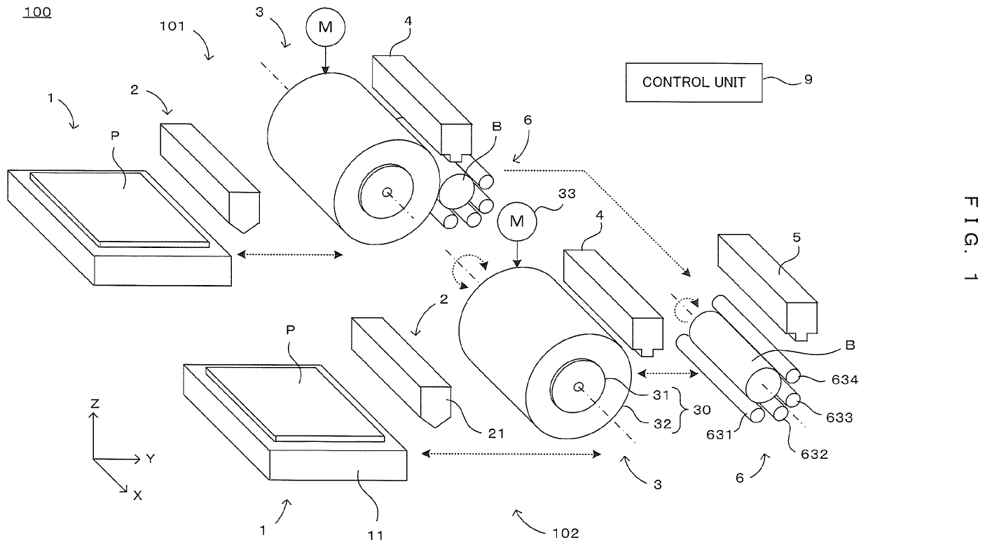

FIG. 1 is a schematic view showing an exemplary schematic configuration of a printing system capable of implementing a printing method according to the present invention. A printing system 100 corresponds to one embodiment of a printing apparatus according to the present invention. The printing system 100 is a system for performing printing on a surface of a printing target material such as a glass bottle or a resin bottle, for example, having an outer shape that is a substantially circular cylindrical shape, more specifically, on a printing target surface that is a circular cylindrical surface. To show directions in the drawings in a unified manner, an XYZ orthogonal coordinate system is set, as shown in FIG. 1. For example, an XY plane can be taken as a horizontal plane, and a Z axis can be taken as a vertical axis. In the following description, a (−Z) direction is defined as a vertically downward direction. In each of the drawings referred to below, arrows with dots added near a constituting element show the motion of this constituting element.

The printing system 100 includes two printing sections each performing printing using one ink color on a printing target material, specifically, includes a first printing section 101 and a second printing section 102. Thus, the printing system 100 can perform two-color printing on the printing target material. A printing system may also be configured as a single-color printing system with one printing section or as a multicolor printing system with three or more printing sections.

Each of the first printing section 101 and the second printing section 102 includes a plate stage unit 1, an ink filling unit 2, a transfer unit 3, a pre-curing unit 4, and a bottle holding unit 6. These units are aligned in the order named as viewed from a (−Y) direction toward a (+Y) direction. A final-curing unit 5 is provided near the second printing section 102. The printing system 100 further includes a control unit 9 that controls the operation of each of these units.

The following describes the configuration and operation of each unit of the apparatus in a case where the printing target material is a circular cylindrical glass bottle or resin bottle (hereinafter simply called a “bottle”) B. The configuration and operation of each unit described herein are those of each unit belonging to the second printing section 102. Except for the omission of the final-curing unit 5, however, each unit of the first printing section 101 has the same configuration and operates in the same way.

In printing processing by the printing system 100, the following steps are executed in the following order:

(1) Formation of an ink pattern by the plate stage unit 1 and the ink filling unit 2 using photo-curing ink;

(2) Transfer of the ink pattern to the transfer unit 3;

(3) Transfer of the ink pattern from the transfer unit 3 to the printing target material; and

(4) Pre-curing of ink by irradiation with light from the pre-curing unit 4.

After each of the printing sections 101 and 102 performs single-printing operation including the foregoing steps (1) to (4), the second printing section 102 performs a following step (5):

(5) Final-curing of the ink by the final-curing unit 5.

More specifically, after the first printing section 101 performs each of the foregoing steps (1) to (4) on the bottle B, the bottle B is delivered from the first printing section 101 to the second printing section 102. Regarding this delivery, only the bottle B may be transported. Alternatively, the bottle holding unit 6 holding the bottle B may be moved from the first printing section 101 to the second printing section 102. In this case, a single bottle holding unit 6 may be provided for both of these printing sections.

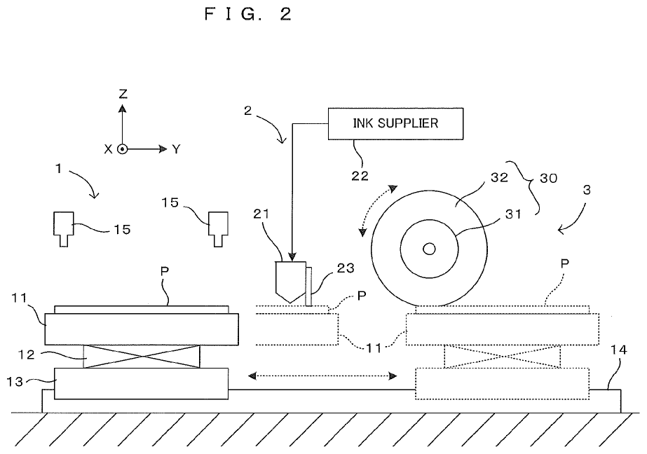

FIG. 2 shows the configurations of the plate stage unit and the ink filling unit. The plate stage unit 1 includes a stage 11 with an upper surface for placement of a plate (engraved plate, for example) P for formation of an ink pattern. The stage 11 is attached through an alignment mechanism 12 to a base 13. The alignment mechanism 12 moves the stage 11 in the XYZ directions and a rotary direction about the Z axis in response to a control signal from the control unit 9. For example, a cross-roller carrying mechanism is usable as the alignment mechanism 12.

The base 13 is engaged with a guide rail 14 arranged on a mount of the printing system 100 and extending in the Y direction. This allows the base 13 to move back and forth in the Y direction along the guide rail 14. More specifically, a driving mechanism not shown in the drawings controlled by the control unit 9 is coupled to the base 13. As the driving mechanism is started, the base 13 moves toward the (−Y) direction and the (+Y) direction. A position within a movable range of the base 13 closest to the (−Y) direction (a position indicated by solid lines in FIG. 2) is a home position of the base 13.

Alignment cameras 15, 15 are arranged above the stage 11 located at the home position. The alignment cameras 15, 15 capture images of an alignment mark provided to an edge of the plate P or the upper surface of the plate P placed on the stage 11, and output resultant image data to the control unit 9. The control unit 9 detects the position of the plate P on the stage 11 and operates the alignment mechanism 12, if necessary, thereby adjusting the position to the plate P to a proper position.

The ink filling unit 2 and the transfer unit 3 are provided along a path of movement of the base 13 from the home position toward the (+Y) direction. The ink filling unit 2 includes a nozzle 21. The nozzle 21 is arranged to face the upper surface of the plate P placed on the stage 11 while the plate P is passing directly below the nozzle 21. The nozzle 21 receives supply of photo-curing ink (hereinafter may be called “ink” simply) from an ink supplier 22 controlled by the control unit 9. The supplied ink is ejected through an ejection opening formed at the lower end of the nozzle 21 and applied to the upper surface of the plate P.

The photo-curing ink contains pigment as a developer, and additionally, a polymer material and a photopolymerization initiator. The polymer material is a material to form a firm polymer layer by polymerization, and contains at least one of monomer and oligomer. The photopolymerization initiator is to facilitate the polymerization reaction of the polymer material using activated species generated by causing chemical change of the photopolymerization initiator in response to light irradiation.

A doctor blade 23 is provided on a side of the nozzle 21 in the (+Y) direction. The doctor blade 23 is used for rubbing a surface of the plate P with the supplied ink and scraping off the ink. By doing so, while recesses in the upper surface of the plate P are filled with the ink, redundant ink other than the filling ink is removed to form an ink pattern.

The plate P filled with the ink in this way is moved further toward the (+Y) direction to reach a position where the transfer unit 3 is arranged. As shown in FIGS. 1 and 2, the transfer unit 3 includes a blanket roll 30 and a motor 33 for rotating the blanket roll 30. More specifically, the blanket roll 30 includes a blanket cylinder 31 that is a circular cylinder made of metal, for example, and a blanket 32 wound on the surface of the blanket cylinder 31. The blanket roll 30 has a substantially circular cylindrical shape as a whole. The blanket roll 30 is supported rotatably by a frame not shown in the drawings. The motor 33 controlled by the control unit 9 drives the blanket roll 30 to rotate about a center axis indicated by a dashed-and-dotted line in FIG. 1.

The blanket 32 is a material made of resin having elasticity such as silicon resin, for example, and can carry an ink pattern on its surface. The blanket 32 has a thickness sufficiently greater than recesses and projections that might be generated on a surface of the bottle B as a printing target material. As shown in FIG. 2, when the plate P placed on the stage 11 passes through a position directly below the blanket roll 30, the surface of the blanket 32 comes into abutting contact with the upper surface of the plate P. At this time, the ink filling the recesses in the plate P is moved to the surface of the blanket 32. In this way, an ink pattern on the plate P is transferred to the blanket 32.

After the ink pattern is transferred (preliminarily transferred) once to the blanket 32 in this way, the ink pattern is transferred secondarily to the surface of the bottle B as a final printing target material. That is, the blanket 32 functions as an intermediate transfer member that temporarily supports the ink pattern to be transferred finally to the printing target material.

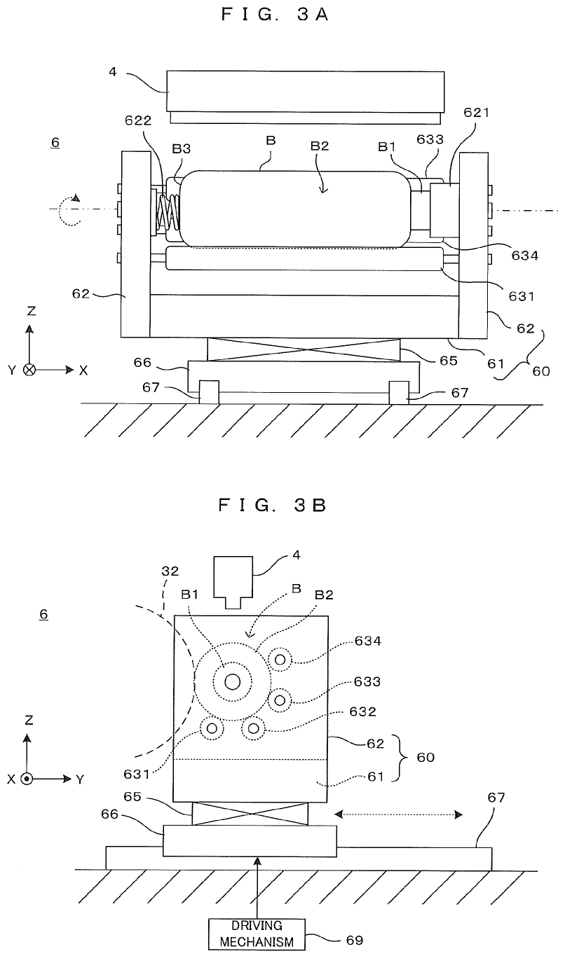

FIGS. 3A and 3B show the configuration of the bottle holding unit. More specifically, FIG. 3A is a side view of the bottle holding unit 6 taken in the Y direction, and FIG. 3B is a side view of the bottle holding unit 6 taken in the X direction.

The bottle holding unit 6 is to hold the bottle B that is a printing target material having a periphery B2 as a printing target surface in such a manner as to make the bottle B rotatable about a center axis thereof. As shown in FIG. 3, the bottle holding unit 6 includes a support frame 60 formed of a combination of a bottom plate 61 and a pair of side plates 62, 62 extending upward from the opposite ends of the bottom plate 61 in the X direction. A coupling member 621 is rotatably coupled to one of the side plates 62. A spring member 622 is provided to the other side plate 62. While an opening part B1 of the bottle B is coupled to the coupling member 621, a bottom surface part B3 of the bottle B is biased by the spring member 622 toward the opening part B1. By doing so, the bottle B is held in a posture in which the center axis thereof extends substantially horizontally. The coupling member 621 is driven to rotate by a motor not shown in the drawings, and can rotate the bottle B about the center axis thereof.

As shown in FIGS. 1 and 3B, the bottle B is supported secondarily by backup rolls 631 to 634 each extending in the X direction as an axis direction. Each of the backup rolls 631 to 634 is supported to be rotatable relative to the both side plates 62. a pair of backup rolls 631 and 632 are provided below the bottle B and abut on the periphery B2 of the bottle B from below, thereby restricting the displacement of the bottle B in a direction of gravitational force, namely, toward the (−Z) direction. Another pair of backup rolls 633 and 634 are provided on a side surface of the bottle B in the (+Y) direction and abut on a side of the bottle B in the (+Y) direction, thereby restricting the displacement of the bottle B toward the (+Y) direction. On the other hand, the periphery B2 of the bottle B on a side in the (−Y) direction is opened widely.

The bottom plate 61 of the support frame 60 is attached to a base 66 via an alignment mechanism 65. The alignment mechanism 65 moves the support frame 60 in the XYZ directions and a rotary direction about the Z axis in response to a control signal from the control unit 9. For example, a cross-roller bearing mechanism is usable as the alignment mechanism 65.

The base 66 is engaged with guide rails 67, 67 arranged on the mount of the printing system 100 and extending in the Y direction, and is allowed to move back and forth in the Y direction along the guide rails 67. More specifically, a driving mechanism 69 controlled by the control unit 9 is coupled to the base 66. As the driving mechanism 69 is started, the base 67 moves toward the (−Y) direction and the (+Y) direction. This allows the bottle B held by the bottle holding unit 6 to move horizontally in the Y direction within a predetermined movable range.

As shown in FIG. 3B, when the bottle holding unit 6 moves the bottle B to a position near an end of the movable range of the bottle B in the (−Y) direction, the side surface of the bottle B in the (−Y) direction is pressed against the surface of the blanket 32. By doing so, an ink pattern carried on the surface of the blanket 32 is transferred to the periphery B2 of the bottle B. The displacement of the bottle B to be caused by reactive force from the blanket 32 generated by pressing the bottle B against the blanket 32 is prevented by the backup rolls 631 to 634 before it occurs. Specifically, the backup rolls 632 to 634 abut on the bottle B on the opposite side of the blanket roll 30 relative to the center of rotation of the bottle B to restrict the displacement of the bottle B to be caused by the pressing against the blanket 32. In this way, a constant contact pressure is maintained at a nip where the bottle B and the blanket 32 abut on each other, thereby achieving stabilized printing quality.

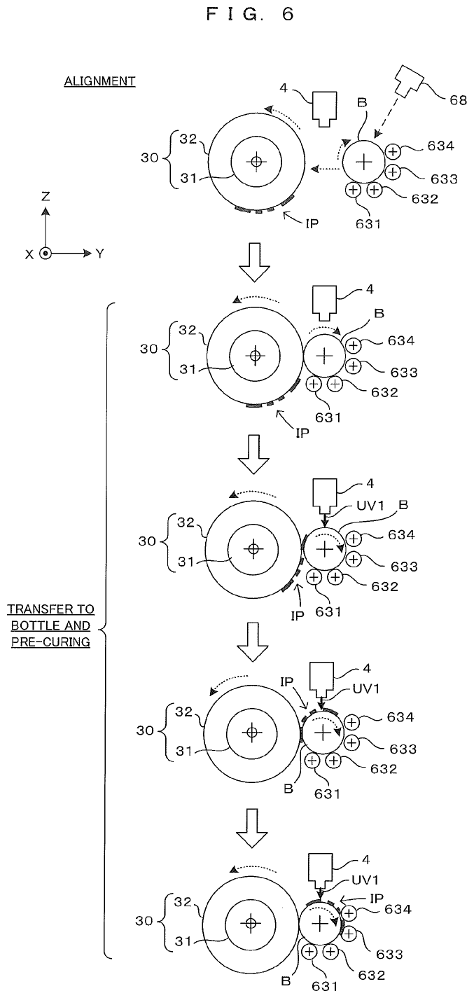

While not shown in FIG. 3A, as described later, an alignment camera 68 (FIG. 6) is further provided for the bottle B for detecting the position of the bottle B held by the bottle holding unit 6. The control unit 9 operates the alignment mechanism 66 on the basis of a result of imaging by the alignment camera 68 to adjust the position of the bottle B, more specifically, adjust a relative position of the bottle B to the blanket 32 to a proper position.

In FIG. 1, the state of the bottle holding unit 6 of the first printing section 101 is such that the bottle B is located at a position separated from the transfer unit 3. On the other hand, the state of the bottle holding unit 6 of the second printing section 102 is such that the bottle B is located beside the transfer unit 3 and abuts on the blanket 32.

As shown in FIG. 1, the pre-curing unit 4 is arranged near the blanket 32 of the transfer unit 3. The pre-curing unit 4 irradiates an ink pattern of photo-curing ink transferred from the blanket 30 to the bottle B with light (ultraviolet light, UV light). The pre-curing unit 4 is not to cure the ink completely but has a function of increasing the viscosity of the ink pattern transferred to the bottle B to a degree not to cause hindrance to implementation of subsequent steps. For this reason, the intensity of outgoing light can be relatively low and a light source with a light emitting diode (LED) to output ultraviolet light is applicable, for example. The pre-curing unit 4 irradiates the ink immediately after being transferred to the bottle B with light. To achieve this, as shown in FIG. 3B, the pre-curing unit 4 is arranged at a position facing the surface of the bottle B located to abut on the surface of the blanket 32.

The final-curing unit 5 is provided near the second printing section 102. The final-curing unit 5 has a function of curing the ink more firmly after the ink is increased in viscosity by the pre-curing. For this reason, a light source to produce high output such as a UV lamp, for example, is used preferably. The final-curing unit 5 is arranged at a position farther from the blanket 32 than the pre-curing unit 4. The reason for this is to avoid irradiation of the ink pattern on the blanket 32 with intense light emitted from the final-curing unit 5.

As described above, the printing system 100 performs light irradiation for curing the photo-curing ink at two stages, irradiation for the pre-curing and irradiation for the final-curing. The printing sections 101 and 102 individually perform the pre-curing of irradiating the ink immediately after being transferred to the bottle B. On the other hand, light irradiation for the final-curing of curing the ink completely is performed after transfer of all ink patterns is finished. For this reason, only one final-curing unit 5 is arranged near the second printing section 102 to perform last transfer, independently of the number of printing sections.

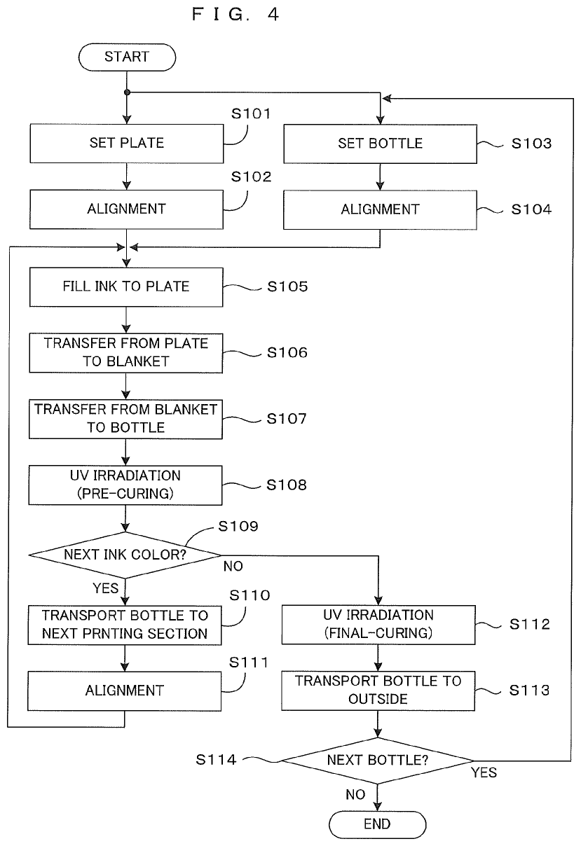

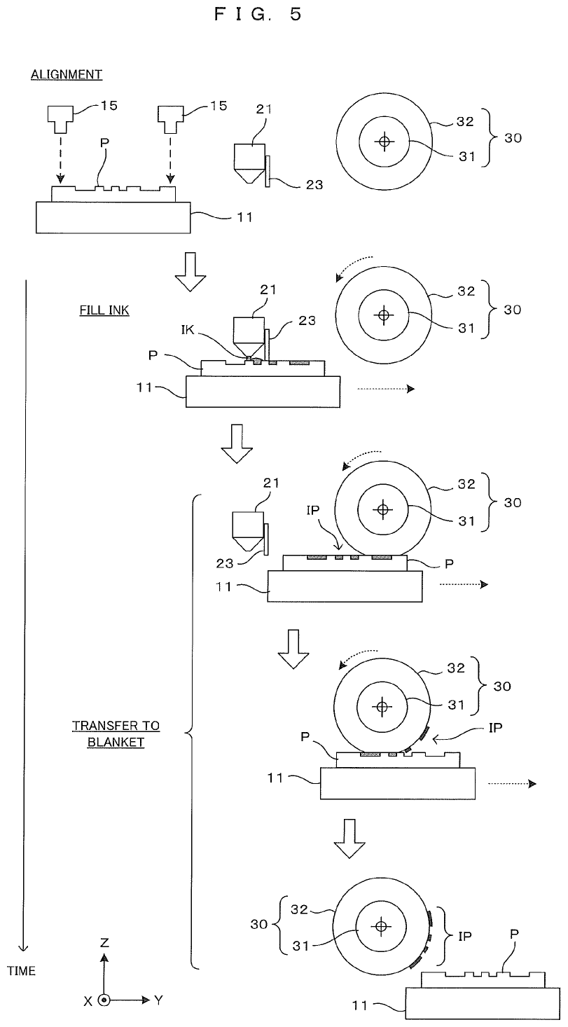

FIG. 4 is a flowchart showing one embodiment of the printing method according to the present invention. FIGS. 5 and 6 schematically show the motion of each unit during the course of implementation of the printing method of FIG. 4. More specifically, FIG. 4 shows an example of printing processing to which the printing method according to the present invention is applied. In FIGS. 5 to 7, arrows with dots show directions of movements of respective members. For implementation of this printing processing, the control unit 9 executes a program stored in advance and causes each component of the apparatus to perform predetermined operation.

In this printing processing, the plate P and the bottle B are placed at the first printing section 101 of the printing system 100. More specifically, the plate P is transported into the first printing section 101 and placed on the stage 11 (step S101). Then, as shown in an upper area of FIG. 5, alignment of the plate P is adjusted on the basis of a result of imaging by the alignment cameras 15 (step S102). Likewise, the plate P is also set and the alignment of the plate P is also adjusted at the second printing section 102. In parallel with these steps, the bottle holding unit 6 performs process on the bottle B. Specifically, after the bottle B as a printing target material is placed (step S103), the bottle B is imaged using the alignment camera 68 as shown in an upper area of FIG. 6. On the basis of a result of the imaging, the alignment of the bottle B is adjusted (step S104).

Next, the stage 11 of the first printing section 101 starts to move toward the (+Y) direction. Then, a plate surface is filled with ink (step S105). Specifically, the upper surface of the plate P is coated with photo-curing ink IK from the nozzle 21 of the ink filling unit 2 and redundant ink is scraped off with the doctor blade 23, thereby filling the ink. As the stage 11 moves further and passes through a position directly below the rotating blanket roll 30, an ink pattern formed on the plate P is transferred to the surface of the blanket 32 (step S106).

FIG. 5 schematically shows the state of each component in a state from placement of the plate P on the stage 11 to transfer of the ink pattern to the blanket 32 by way of the alignment adjustment and the ink filling. As shown in a lower area of FIG. 5, an ink pattern IP formed on the plate P is finally transferred in its entirety to the blanket 32.

FIG. 6 schematically shows the state of each component from placement of the bottle B at the bottle holding unit 6 to transfer of the ink pattern IP from the blanket 32 to the bottle B. In parallel with the foregoing process on the plate P, the bottle holding unit 6 performs process on the bottle B. Specifically, the bottle B is placed at the bottle holding unit 6 and the alignment of the bottle B is adjusted (steps S103, S104). Then, the bottle holding unit 6 moves toward the (−Y) direction and brings the bottle B into abutting contact with the surface of the blanket 32. By doing so, the ink pattern IP is transferred from the blanket 32 to the bottle B.

As shown in FIG. 6, the blanket 32 with the transferred ink pattern IP and the bottle B rotate in conjunction with each other while abutting on each other, thereby transferring the ink pattern IP on the surface of the blanket 32 gradually to the bottle B. FIG. 5 shows steps from incoming transport of the plate P to transfer of the ink pattern to the blanket 32. FIG. 6 shows steps from incoming transport of the bottle B to transfer of the ink to the bottle B. These steps in the respective drawings are illustrated as steps independent of each other. In the actual implementation of the process, however, transfer of the ink pattern to the blanket 32 and transfer of the ink pattern from the blanket 32 to the bottle B can be performed continuously during same turn of the blanket 32.

The surface of the bottle B abuts on the backup rolls 631 to 634. When the ink pattern IP reaches positions of abutting contact with the backup rolls 631 to 634 in response to the rotation of the bottle B, uncured ink may be transferred from the bottle B to the backup rolls 631 to 634. If the bottle B rotates one turn or more, the ink pattern IP on the surface of the bottle B may disadvantageously be re-transferred to the blanket 32. These cause disturbance of the ink pattern on the surface of the bottle B, and cause contamination of the blanket 32 or the backup rolls 631 to 634 with the ink.

To prevent these problems, pre-curing process is performed through irradiation ultraviolet light of a relatively small exposure amount (step S108). Specifically, as shown in FIG. 6, light (ultraviolet light) UV1 is applied from the pre-curing unit 4 toward the surface of the bottle B immediately after the ink pattern IP is transferred from the blanket 32. The light UV1 applied from the pre-curing unit 4 causes polymerization of part of the polymer material in the ink to increase the viscosity of the ink. At this time, as will be described later, the curing is not such a level as to cure the ink entirely.

Increasing the viscosity of the ink in this way reduces adhesion to a different object. This prevents the ink from being transferred to the backup rolls 631 to 634 or the blanket 32 when the surface of the bottle B on which the ink is carried comes into contact with the backup rolls 631 to 634 or the blanket 32.

In some cases, an additional ink pattern is printed on the bottle B to be superimposed on an ink pattern already transferred to the bottle B. These cases are responsive to a need to increase the thickness of a printing layer by superimposing ink patterns of the same color or a need to perform multicolor printing by superimposing ink patterns of different colors, for example.

For implementation of such superimposed printing, an ink pattern already transferred to the bottle B is preferably in a state of not being cured completely. The reason for this is that superimposing a layer of an additional ink pattern on a layer of a completely cured ink pattern causes deterioration of adhesion between the layers. On the other hand, if the viscosity of the ink pattern already transferred is too low, inks of different colors may be mixed with each other or the ink may be re-transferred from the bottle B to the blanket 32, causing reduction in printing quality.

In the printing processing of the present embodiment, ink already transferred is adjusted at proper viscosity by the foregoing pre-curing to prevent the occurrence of the problems described above. Specifically, by transferring an additional ink pattern gradually to the bottle B with an ink pattern already transferred to the bottle B being pre-cured, superimposed printing in multiple layers is performed favorably. More specifically, the superimposed printing can be performed in the following way.

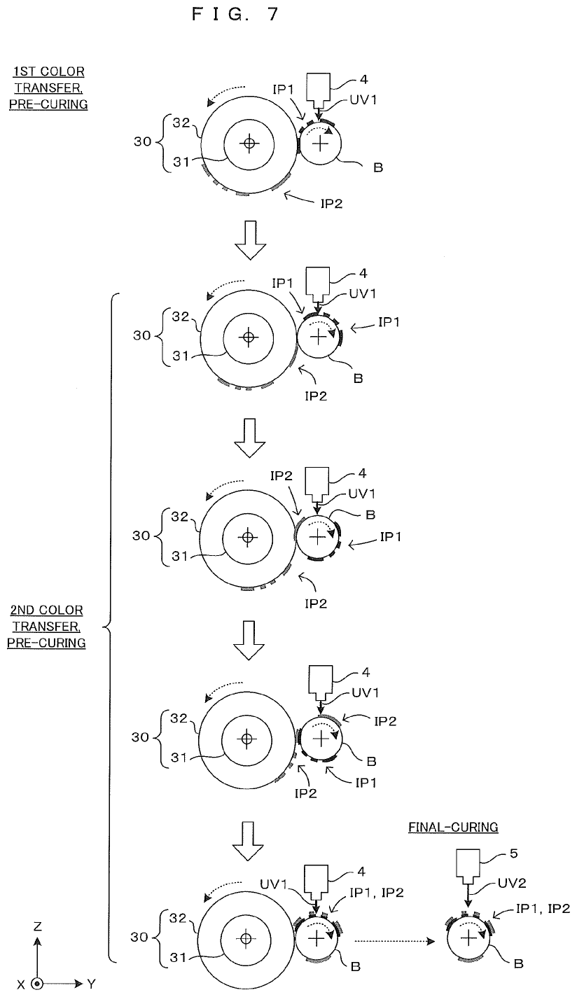

FIG. 7 schematically shows the motion of each component during the superimposed printing. In a first assumed case, ink patterns of the same color are to be superimposed on each other. If the length of an ink pattern in a peripheral direction to be transferred to the blanket 32 is longer than the length of the perimeter of the bottle B at one printing section such as the first printing section 101, for example, the bottle B is to rotate more than one turn before the ink pattern is transferred entirely. As a result, a pattern to be transferred during a second turn is superimposed on a pattern transferred during a first turn.

That is, as shown in FIG. 7, after an ink pattern IP1 is transferred during the first turn of the bottle B, an ink pattern IP2 remaining on the surface of the blanket 32 is to be transferred to the bottle B during the second turn or its subsequent turn of the bottle B. At this time, superimposed printing in two layers is fulfilled by transferring the additional ink pattern IP2 to a region of the surface of the bottle B to which the ink pattern IP1 is already transferred. Such superimposed printing can be performed easily by setting the length of the plate P in the Y direction to be sufficiently longer than the length of the perimeter of the bottle B. In FIG. 7, to improve the viewability of the drawing, the ink pattern IP1 to be transferred during the first turn and the second ink pattern IP2 to be transferred during the second turn are shown in different densities.

In this case, as ink immediately after being transferred is irradiated with the light UV1 from the pre-curing unit 4 to be pre-cured, re-transfer of the ink from the bottle B to the blanket 32 is prevented. Further, as this ink is not cured completely, no issue is raised about adhesion to ink to be transferred additionally. Then, final-curing process is preformed after completion of the superimposed printing to allow the transferred ink patterns IP1 and IP2 to be cured completely entirely. In this way, the superimposed printing producing good quality is achieved.

In a case assumed next, inks of different colors or different types are to be printed to be superimposed on each other (YES in step S109). This can be understood by considering that the ink pattern IP1 and the ink pattern IP2 in FIG. 7 are to be formed using different ink colors. For example, if two-color printing is to be performed by the first printing section 101 and the second printing section 102, the ink pattern IP1 of a first color is transferred to the bottle B, and subjected to light irradiation for pre-curing by the pre-curing unit 4 at the first printing section 101. Then, the bottle B is transported to the second printing section 102 responsible for the next printing (step S110). Then, the alignment of the transported bottle B is adjusted again (step S111).

Next, the second printing section 102 also performs filling of a plate surface with ink (step S105), transfer of the ink pattern IP2 from the plate P to the blanket 32 (step S106), transfer from the blanket 32 to the bottle B (step S107), and pre-curing of the ink by irradiation with light from the pre-curing unit 4 (step S108). At this time, the ink pattern IP1 already transferred to the bottle B is in a state of increased viscosity by the implementation of the pre-curing, thereby preventing re-transfer of the ink pattern IP1 to the blanket 32. As the additional ink pattern IP2 is to be transferred to be superimposed on the ink pattern IP1 in an uncured state, good adhesion between layers is obtained. In the presence of three or more ink colors, printing sections of a number responsive to the number of the colors are provided, and ink patterns transferred at the respective printing sections are stacked on the surface of the bottle B.

At the time when the transfer and pre-curing of the ink patterns of the respective colors are finished as described above (NO in step S109), the inks are not cured completely. To cure these inks completely, the final-curing process is performed using the final-curing unit 5 (step S112). As shown in a lower area of FIG. 7, the final-curing process is performed by irradiating the bottle B with light (ultraviolet light) UV2 from the final-curing unit 5 while the bottle B is largely separated from the blanket 32. This irradiation with the light UV2 is performed with an exposure amount sufficient for curing the inks completely.

After the bottle B is subjected to the printing processing in the foregoing way, the bottle B is transported to the outside (step S113). In the presence of a bottle to be printed next (YES in step S114), the flow returns to step S103 to repeat the foregoing processing from incoming transport of the bottle B. Regarding the plate P used for a series of the printing processing, setting of the plate P including the alignment adjustment in steps S101 and S102 has already been done at each of the printing sections 101 and 102. Thus, only by changing bottles B sequentially, printing on a plurality of the bottles B can be performed continuously through repeated implementation of the foregoing processing.

This printing processing requires pre-curing performed by irradiating ink with light immediately after the ink is transferred to the bottle B. This causes the necessity of locating the pre-curing unit 4 near the blanket 32. Due to this, if the light UV1 emitted from the pre-curing unit 4 leaks, the leaking light UV1 may reach the blanket 32 and the ink carried on the blanket 32 may disadvantageously be irradiated with the light.

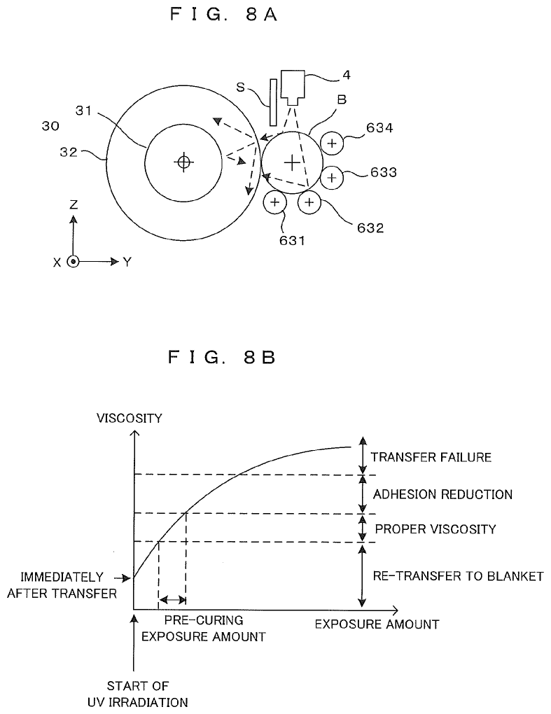

FIGS. 8A and 8B are drawings explaining a problem relating to leakage of light to the blanket. As shown in FIG. 8A, light from the pre-curing unit 4 to travel directly toward the blanket 32 can be reduced by providing an appropriate light shielding member S between the pre-curing unit 4 and the blanket 32. However, if the surface of the bottle B has light reflectivity or if a material itself for forming the bottle B has light-transmitting properties, the light UV1 may enter the blanket 32 through the surface or the interior of the bottle B. In particular, if the bottle B is made of a transparent material, the entering light causes notable influence. If the blanket 32 is made of silicon resin, this material itself has ultraviolet transmitting properties of a certain level. Such unexpected light irradiation causes a risk of increasing the viscosity of ink on the blanket 32. Arrows with underlines in FIG. 8A show examples of optical paths of stray light caused in the foregoing cases.

No serious problem is to occur if transfer of ink from the blanket 32 to the bottle B and irradiation of the transferred ink with light can be performed separately. The reason for this is that irradiation of ink on the blanket 32 with light can be avoided by delaying the light irradiation until completion of the transfer. However, such printing process results in low productivity. Hence, in a practical case, overlap between the transfer of the ink from the blanket 32 to the bottle B and the light irradiation for pre-curing is unavoidable, even if it occurs temporarily.

FIG. 8B schematically shows a relationship between an exposure amount and ink viscosity. As shown in FIG. 8B, in response to increase in the exposure amount expressed by the intensity of irradiation light and irradiation time, the viscosity of ink is also increased. Once the ink is cured completely, the viscosity thereof is not increased further. At the stage of the pre-curing, viscosity is required to be maintained at such a high level as not to cause re-transfer of the ink to the blanket 32, etc., and to be maintained at a proper level not reaching viscosity to cause reduction in adhesion between layers. Specifically, an exposure amount during the pre-curing is required to be controlled so as to achieve proper viscosity of the ink at the time of completion of the pre-curing.

In the present embodiment, the relatively-low light UV1 is used for the pre-curing. As a result of low light intensity, an exposure amount can be controlled relatively easily by controlling irradiation time. The low irradiation light intensity further makes it possible to impose limitation on the influence by the foregoing light transmission inside the bottle B. More specifically, the light UV1 to be emitted from the pre-curing unit 4 may be set to achieve a minimum of an exposure amount required for increasing the viscosity of the ink to proper viscosity, namely, to achieve an exposure amount approximate to a lower limit of “pre-curing light exposure amount” shown in FIG. 8B. By doing so, it becomes possible to prevent the viscosity of the ink at the time of the pre-curing stage from increasing to a level exceeding a proper range, even in consideration of the occurrence of leakage of light through the bottle B.

In some cases, an exposure amount required for obtaining proper viscosity differs between ink types. Even in such cases, as a result of the provision of the pre-curing unit 4 to each of the printing sections 101 and 102 individually, an irradiation condition can still be optimized in response to corresponding ink.

As described above, in the printing system 100 of the present embodiment, printing using photo-curing ink is performed on a printing target material such as a glass bottle having a printing target surface like a circular cylindrical surface. Light irradiation for curing the photo-curing ink is performed at two stages. During light exposure for pre-curing performed with the bottle B abutting on the blanket 32, a relatively small exposure amount of such a degree as to increase the viscosity of ink to predetermined proper viscosity is used. This prevents the ink transferred to the bottle B from being re-transferred to the backup rolls 631 to 634 or the blanket 32. This further makes it possible to prevent mixture of inks to be caused when an ink pattern of the same color or a different color is transferred to be superimposed on an ink pattern already transferred. This also achieves increased adhesion between layers to prevent separation between the ink patterns. This further makes it possible to prevent the occurrence of failure in transfer to the bottle B due to curing of the ink on the blanket 32 with light leaking through the bottle B.

On the other hand, after the ink patterns in corresponding layers are superimposed on each other, the final-curing unit 5 performs irradiation with the light UV2 for final-curing for curing these ink patterns completely. An exposure amount in this stage is required to be an amount for curing ink completely and thus is sufficiently larger than that at the time of the pre-curing. As a result, the transferred ink patterns can be cured completely entirely. The final-curing is not required to be performed immediately after the transfer and can be performed with the bottle B separated from the blanket 32. This makes it possible to prevent curing of the ink on the blanket 32 to be caused by light irradiation.

As described above, according to the foregoing embodiment, the blanket 32 functions as an “intermediate transfer member” of the present invention, and the bottle holding unit 6 functions as a “holder” of the present invention. The motor 33 functions as a “driver” of the present invention. The backup rolls 631 to 634 function as a “backup member” of the present invention. The ink patterns IP, IP1, and IP2 correspond to a “printing pattern” of the present invention. The pre-curing unit 4 functions as a “first light irradiator” of the present invention. The light UV1 emitted from the first light irradiator corresponds to “first light” of the present invention. The final-curing unit 5 functions as a “second light irradiator” of the present invention. The light UV2 emitted from the second light irradiator corresponds to “second light” of the present invention.

In the printing processing (FIG. 4) in the foregoing embodiment, steps S105 and S106 correspond to a “first step” of the present invention, and step S107 corresponds to a “second step” of the present invention. Further, steps S108 and S112 correspond to a “third step” and a “fourth step” respectively of the present invention.

Note that the invention is not limited to the above embodiment and various changes other than the aforementioned ones can be made without departing from the gist of the invention. For example, in the printing system 100 of the foregoing embodiment, the final-curing unit 5 is provided to the second printing section 102. However, since re-transfer of ink to a different member is prevented at the bottle B after being subjected to the pre-curing process, the bottle B in this state can be transported from the printing system 100 to the outside. Thus, a processing apparatus responsible for the final-curing may be provided separately from the printing system. Such a configuration eliminates a need for ensuring processing time for the final-curing in the operation sequence in the printing system. This increases working efficiency of the system to encourage throughput increase. In this case, a plurality of bottles B already being subjected to the pre-curing may be irradiated collectively with light for the final-curing.

In the printing system 100 of the foregoing embodiment, the plate stage 11 moves the plate P relative to the fixed blanket roll 30 and the bottle holding unit 6 moves the bottle B relative to the fixed blanket roll 30, thereby determining the relative positions for the printing processing. These movements are only required to be made relative to each other, and a unit to be configured as a movable unit is not limited to the foregoing but can be determined freely.

Further, in the foregoing embodiment, an ink pattern is formed by coating the engraved plate with ink and scraping off the ink with the doctor blade. However, this is not the only method of forming the ink pattern but the ink pattern may formed by any method. For example, in one configuration, an ink pattern formed on a flat plate using an inkjet printer may be transferred to a blanket. In another configuration, an ink pattern may be formed directly on a surface of a blanket using an inkjet printer. Additionally, the blanket 32 of the foregoing embodiment has a cylindrical shape with a surface that is a circular cylindrical surface. However, the intermediate transfer member of the present invention is not limited to this. For example, a blanket to be used may be a shape like an endless belt wound on a roller.

In the foregoing embodiment, a light source of the pre-curing unit 4 is a UV-LED, and a light source of the final-curing unit 5 is a UV lamp. However, the light sources are not limited to these but any type of light source capable of emitting light of a required wavelength and required intensity is applicable. A wavelength may be different between light for the pre-curing and light for the final-curing.

In the foregoing embodiment, the photo-curing ink is used and the ink is cured by irradiation with light (UV light). As an alternative to this, however, a configuration of using thermosetting ink and curing the ink by irradiation with infrared light is also applicable, for example. In this case, a small exposure amount can also be set for light irradiation for the pre-curing, and a larger exposure amount can also be set for light irradiation for the final-curing. By doing so, it becomes possible to maintain the viscosity of the ink at an appropriate state during the progress of the printing processing.

The bottle holding unit 6 of the foregoing embodiment is configured to sandwich the bottle B as a printing target material between the coupling member 621 and the spring member 622 and to support the bottle B secondarily using the backup rolls 631 to 634. However, a configuration of holding the printing target material is not limited to this but any holding configuration is applicable. In one configuration, the printing target material may be held by an appropriate rotary chuck mechanism, for example.

A printing target material of the foregoing embodiment is the bottle B having a substantially circular cylindrical shape. However, the printing target material is not limited to this. For example, printing processing using the printing processing system 100 described above can also be performed on a printing target material having a tubular shape with open opposite ends or a printing target material with recesses or projections provided in a surface thereof that is a generally circular cylindrical surface.

As understood from the illustration and description of the specific embodiment given above, in the printing method according to the present invention, the second step may be configured to rotate a printing target material more than one turn. This configuration makes it possible to transfer a layer of an additional printing pattern to be superimposed on a printing pattern transferred during a first turn. In this case, if the layer transferred previously is in a completely cured state, adhesion of this layer with the layer to be transferred later may be reduced. According to the present invention, as the ink is not cured completely by the light irradiation in the third step, such adhesion reduction can be suppressed.

The present invention may be configured in such a manner that, after the second step and the third step are performed on one ink color, the second step and the third step are performed on a different color, and then the fourth step is performed. In such printing that is so-called multicolor printing, as a layer of the ink color transferred previously is not cured completely, reduction in adhesion such as that observed between layers can also be suppressed.

According to the present invention, the exposure amount of light to the printing target surface given by the first light is preferably smaller than an exposure amount required for curing the ink. This prevents the viscosity of the ink from becoming higher than is necessary, making it possible to reliably prevent the reduction in adhesion between layers described above.

The second light may be more intense than the first light. The second light is to cure the ink completely. To ensure an exposure amount necessary for the curing, the light intensity of the second light is preferably sufficiently high. Further, unlike the first light, the second light is not required to be used for irradiation immediately after transfer. For this reason, the printing target material can be located away from the intermediate transfer member during irradiation with the second light. As a result, irradiation of the intermediate transfer member with the high intense light can be avoided.

In the printing method according to the present invention, the transfer in the second step and the light irradiation in the third step may be performed simultaneously at least in a certain period of time. Part of the light used for the light irradiation in the third step can become a cause for change in viscosity of the ink occurring in the second step. According to the present invention, however, this problem is resolved by giving consideration to the photopolymerization initiator and the wavelength of the irradiation light. Thus, performing these steps simultaneously does not cause any problem.

For example, the printing target material may have light-transmitting properties. In this case, it is impossible in fact to control light to transmit through the interior of the printing target material and to enter the intermediate transfer member. According to the present invention, however, influence by variation in an exposure amount on the viscosity is limited as described above, making it possible to avoid trouble to result in degradation of printing quality such as re-transfer of the ink or transfer failure of the ink.

The printing apparatus according to the present invention may be configured in such a manner that the intermediate transfer member includes a blanket made of elastic resin with a surface having a shape of a circular cylindrical surface, and the blanket with a printing pattern supported on the surface rotates while abutting on the printing target material, thereby transferring the printing pattern to the printing target material. In this configuration, the provision of the blanket for temporarily supporting the printing pattern makes it possible to easily respond to change in a printing pattern or a printing target material. Further, the surface of the blanket with elasticity is capable of conforming to recesses and projections in the surface of the printing target material. Thus, even if the printing target material is not a perfect circular cylindrical member, printing can still be performed favorably on the printing target material.

The backup member may include a plurality of roller members abutting on the printing target surface on the opposite side of the intermediate transfer member relative to the center of rotation of the printing target material. This configuration allows the position of the printing target material to be maintained against pressing force from the intermediate transfer member, making it possible to transfer the printing pattern stably.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

### INDUSTRIAL APPLICABILITY

The present invention is applicable to printing technique as a whole for performing printing on a printing target material such as a glass bottle or a resin bottle having a circular cylindrical surface as a printing target surface.

### REFERENCE SIGNS LIST

3 transfer unit
4 pre-curing unit
5 final-curing unit
6 bottle holding unit
32 blanket (intermediate transfer member)
33 motor (driver)
69 driving mechanism
100 printing system (printing apparatus)
631-634 backup roll (backup member)
B bottle (printing target material)
IP, IP1, IP2 ink pattern (printing pattern)
P plate
S105-S106 first step
S107 second step
S108 third step
S112 fourth step
UV1 first light
UV2 second light

1. A printing method for printing on a printing target material having a circular cylindrical surface as a printing target surface, comprising:
a first step of forming a printing pattern of ink on a surface of an intermediate transfer member;
a second step of supporting the printing target material by making a backup member abut on the printing target surface and of transferring the printing pattern to the printing target surface by causing the printing target surface to abut on the surface of the intermediate transfer member and by causing the printing target material to roll along the surface of the intermediate transfer member;
a third step of increasing viscosity of the ink to predetermined viscosity by irradiating the printing pattern transferred to the printing target surface with first light; and
a fourth step of curing the ink by irradiating the printing pattern with second light, wherein
in the third step, the first light is applied to a region of the printing target surface of the printing target material abutting on the intermediate transfer member and rolling, the region being a part of the printing target surface in a state that after departing from the intermediate transfer member and before abutting on the backup member, and
in the fourth step, the second light is applied while the printing target material is separated from the intermediate transfer member.

2. The printing method according to claim 1, wherein the printing target material is rotated more than one turn in the second step.

3. The printing method according to claim 1, wherein after transferring the printing pattern and irradiating the first light on one ink color, the second step and the third step are performed on a different color, and then the fourth step is performed.

4. The printing method according to claim 1, wherein an exposure amount to the printing target surface given by the first light is smaller than an exposure amount required for curing the ink.

5. The printing method according to claim 1, wherein the second light is more intense than the first light.

6. The printing method according to claim 1, wherein transfer in the second step and light irradiation in the third step are performed simultaneously at least in a certain period of time.

7. The printing method according to claim 1, wherein the ink is photo-curing ink and each of the first light and the second light is ultraviolet light.

8. The printing method according to claim 1, wherein the ink is thermosetting ink and each of the first light and the second light is infrared light.

9. The printing method according to claim 1, wherein the printing target material has light-transmitting property.

10. A printing apparatus for printing on a printing target material having a circular cylindrical surface as a printing target surface, comprising:
an intermediate transfer member which temporarily holds a printing pattern of ink;
a holder which holds the printing target material by making a backup member abut the printing target surface and make the printing target surface abut on a surface of the intermediate transfer member;
a driver which rolls the printing target material along the surface of the intermediate transfer member;
a first light irradiator which irradiates the printing target surface with first light at a position downstream from an abutting position with the intermediate transfer member and upstream from an abutting position with the backup member as viewed in a moving direction of the printing target surface of the printing target material and increases viscosity of the ink to predetermined viscosity;
a mover which moves the printing target material after being irradiated with the first light and the intermediate transfer member relative to each other to positions separated from each other; and
a second light irradiator which irradiates the printing target material separated from the intermediate transfer member with second light and cures the ink.

11. The printing apparatus according to claim 10, wherein
the intermediate transfer member includes a blanket which is made of elastic resin with a surface having a circular cylindrical shape, and
the blanket carrying the printing pattern on its surface rotates while abutting on the printing target material and transfers the printing pattern to the printing target material.

12. The printing apparatus according to claim 10, wherein the backup member includes a plurality of roller members abutting on the printing target surface on an opposite side of the intermediate transfer member relative to a center of rotation of the printing target material.

13. The printing apparatus according to claim 10, wherein the ink is photo-curing ink and each of the first light and the second light is ultraviolet light.

14. The printing apparatus according to claim 10, wherein the ink is thermosetting ink and each of the first light and the second light is infrared light.
